(19) United States
(12) Patent Application Publication
(10) Pub. No.: US 2025/0028888 A1
(43) Pub. Date: Jan. 23, 2025

(54) WAVEFORM CALCULATION USING HYBRID EVALUATION AND SIMULATION APPROACH

(71) Applicant: Synopsys, Inc., Sunnyvale, CA (US)

(72) Inventors: Ajay Singh Bisht, San Jose, CA (US); Alexander John Wakefield, Fort Lauderdale, FL (US); Arjun Prasad Singh, Ghaziabad (IN); Jayanta Roy, San Jose, CA (US); Nishikant Dubey, San Jose, CA (US)

(21) Appl. No.: 18/775,866

(22) Filed: Jul. 17, 2024

(30) Foreign Application Priority Data
Jul. 20, 2023 (IN) 202341048819

(51) Int. Cl. G06F 30/3308

(52) U.S. Cl. CPC G06F 30/3308

(57) ABSTRACT

Aspects of the present disclosure relate to waveform calculation using a hybrid evaluation and simulation approach. Using one or more processors, one or more first portions of a design that are capable of being evaluated using waveform propagation are identified. The identified one or more first portions of the design are evaluated using waveform propagation. One or more second portions of the design that are not capable of being evaluated using waveform propagation are identified. Operation of the one or more second portions of the design is simulated.

### RELATED APPLICATION

This application claims priority to and the benefit of Indian Provisional Patent Application No. 202341048819, filed on Jul. 20, 2023, which is incorporated herein by reference in its entirety.

### BACKGROUND

Designing a circuit may be an arduous process, particularly for today's complex System-on-Chip (SoC) circuits. The design is commonly thoroughly tested to ensure functionality, specifications, and reliability. The importance of these tests prior to tape out and fabrication is significant as the costs and complexity of tape out and fabrication is substantial. Fabricating a circuit that does not meet the necessary specification, does not operate as intended, and/or is not reliable may result in large, wasted costs. However, the speed with which technology is evolving is driving the desire to reduce the time that these tests, and any resulting debug or redesign, use.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1 shows a two-stage pipelined adder.

FIGS. 2A and 2B show examples of feedback loops.

FIGS. 3A and 3B show examples of feedback loops around unmapped and mapped circuit elements, respectively.

FIGS. 4A and 4B show examples of feedback loops with an inner loop and outer loop, where the outer loops are around unmapped and mapped circuit elements, respectively.

FIG. 5 is a flow chart of a method of a hybrid waveform propagation and simulation approach according to some examples.

FIGS. 6A, 6B, and 6C illustrate example circuit elements where a constant logical value on an input pin of the respective circuit element results in a constant logical value on an output pin of the circuit element, such that the waveform on the output pin is known, according to some examples.

FIGS. 7A, 7B, and 7C illustrate example circuit elements where a constant logical value on an input pin of the respective circuit element results in a known constant waveform on an output pin of the circuit element, such that the waveform on the output pin is known, according to some examples.

FIG. 8 shows a loop that is broken according to some examples.

FIG. 9 illustrates aspects of simulation according to some examples.

FIG. 10 depicts a flowchart of various processes used during the design and manufacture of an integrated circuit in accordance with some embodiments of the present disclosure.

FIG. 11 depicts a diagram of an example computer system in which embodiments of the present disclosure may operate.

### DETAILED DESCRIPTION

Aspects of the present disclosure relate to waveform calculation using a hybrid evaluation and simulation approach. To accurately calculate power for a gate-level design, the activity or waveform values for pins or nodes in the gate-level design should be determined. Performing gate-level simulation may be problematic because the simulation environment often including a testbench and gate-level netlist may become available late in the design cycle, and the testbench and gate-level netlist may be difficult to debug for correct functionality. Using register transfer language (RTL) stimulus, a mapping file, and gate-level simulation may solve schedule and debug issues. However, due to simulation-based scheduling algorithms, efficiency for a single application or distributed approach may be slow.

Waveform propagation methods allow efficient distributed calculation of waveform data if all sequential elements (e.g., flip-flops) are known—e.g., that a waveform on a pin of a respective sequential element is known by mapping or is capable of being calculated deterministically. This may solve debug, schedule, and efficiency problems. However, this approach may suffer from problems when retimed flip-flops are present in the design (e.g., there is no equivalent RTL signal) or missing RTL-to-gate mapping entries occur. In these cases, the waveform engine often cannot calculate the logic associated with these problematic sequential elements.

Some examples described herein implement a combination of distributed waveform propagation for circuit elements of a design where using waveform propagation is possible and a distributed simulation approach for other circuit elements. Generally, a first portion(s) of a design that may be evaluated using waveform propagation is identified, and second portions of the design that are not capable of being evaluated using waveform propagation are identified. The first portion(s) is evaluated using waveform propagation. The second portions may be separated into independent clusters. Each cluster may be a minimal, non-deterministic group of circuit elements. The clusters may be simulated, e.g., using a time-based simulation, in parallel. Then, waveforms generated from the simulation may be merged with waveforms that are mapped and/or generated by the waveform propagation to generate a waveform set. Using another waveform propagation based on the waveform set, any unknown waveforms may be determined. Power analysis using the waveforms may then be performed. Such processes may solve debug, schedule, efficiency, and evaluation rate issues. Some examples described herein may solve the problem of waveform evaluation when all gate-level sequential elements do not have a known waveform (typically from RTL simulation). A design or circuit design includes any representation of a circuit in the process of being designed for fabrication. A design or circuit design may also be referred to as design under test (DUT). A design or circuit design may take any appropriate form, such as in RTL, a gate-level netlist, another hardware description language (HDL), or any other representation.

Accordingly, technical advantages of the present disclosure include, but are not limited to, an efficient waveform calculation approach that uses fewer computing resources and that may be parallelized. Waveform propagation may be a much more efficient process for determining waveforms compared to a time-based simulation, which may reduce the amount of computing resources required to determine waveforms. Further, since simulation may be performed on clusters, rather than on a whole design, the simulation of clusters may be performed in parallel, which may permit for linear scaling of simulation time as designs increase in complexity. This approach may be scalable to larger computing platforms and may reduce time for calculating power consumption of a design. Other and/or additional advantages and benefits may be achieved by various examples.

According to some examples, the design is analyzed to identify which portions of the design can be calculated using waveform propagation. Any circuit element with all input pins known may have an output pin for which a waveform may be calculated using waveform propagation. A circuit element with an input pin(s) at a constant logical value and another input pin that has a known waveform or is unknown can also have a known waveform, which may be a constant logical value or a known constant waveform, on an output pin of the circuit element depending on the function of the circuit element. These portions of the design are evaluated using waveform propagation techniques. These portions of the design may have an output waveform on an output pin that is deterministic.

Other portions of the design that are not evaluated using waveform propagation are split into clusters of circuit elements. These portions of the design may have some waveforms of input pins known (e.g., as a result of mapping and/or waveform propagation), but an output waveform on an output pin may be non-deterministic. Each cluster may be a minimal, non-deterministic group of circuit elements. The waveform on the output pin may be non-deterministic when the portion of the design includes a feedback loop, which may cause the waveform to depend on a state of the portion of the design, which state may be unknown. A feedback loop may be broken by marking a pin in the loop such that a waveform on the pin and obtained by the simulation of the corresponding cluster may be saved. Each cluster can be grouped with other unrelated clusters for simulation, memory, and task efficiency reasons. Each cluster is then simulated using gate-level simulation techniques. The clusters may be small, and a single simulation may be used for all time ranges that may be required. It is possible to split a time range to multiple independent time segments if required, e.g., for performance and turn-around time reasons. Some overlap between time slices is also possible to increase the chance of correct state values and minimize initial state errors at the start of each slice. The result includes waveforms of pins being known, by adding the simulation-based waveforms into the evaluation waveform result set.

Thereafter, any unknown portions of the design may be evaluated using waveform propagation. Some deterministic portions of the design may have a cluster (e.g., a non-deterministic portion) in a fan-in of the respective portion. Once a waveform of the respective cluster is obtained through simulation, waveform propagation may be used to determine waveforms of any output pins of circuit elements that were previously unknown.

Simulation approaches to calculate gate-level waveforms may involve a few simple steps. A mapping file is used to specify the equivalent RTL waveforms for various gate-level nodes or pins. This is often the majority of sequential output pins, embedded memory or macro cell pins, and the top level input/output (I/O) pins of the design. The gate-level design may have a large number of points with RTL waveforms available from an RTL activity source. A gate-level simulation environment is created and run. The gate-level simulation injects or forces values for all mapped pins at time points. The values for the mapped pins of circuit elements (e.g., sequential and other elements) match the RTL activity. Combinational and unmapped sequential elements are simulated, and all values of pins are calculated from the functional model of each circuit element. Any pin of a circuit element that is mapped does not require calculation since the values for such pin are the RTL activity. It is possible that unmapped pins of sequential elements have a random or unknown initial value. Some simulation approaches allow a pre-set initial value if this is available. If this value is not available, calculated values will be used. Most of values of the unmapped pins of sequential elements typically eventually trend towards the correct value. For power estimation, this is typically sufficient.

Waveform propagation approaches differ from the simulation approach by grouping the design into a large number of highly connected clusters. Each cluster has inputs waveforms that are known, which allows the respective cluster to be evaluated independently of other clusters. The cluster could be as small as a single combinational gate, and the evaluation engine iterates over circuit elements in the design. This approach allows the calculation to be highly distributed, as the large number of clusters can be efficiently statically or efficiently dynamically scheduled to a set of waveform evaluation engine/workers. A challenge with waveform evaluation may occur when some flip-flops or important signals in the design do not have a known waveform. Either the mapping file from RTL-to-gate has a missing entry, or a pin of the sequential element does not have an equivalent RTL signal. The former often occurs when test logic is inserted, or a synthesis optimization occurs, and the tools do not maintain the mapping data. The later may occur due to synthesis retiming. In this case, there may be no equivalent RTL signal for a pin of a gate-level sequential element.

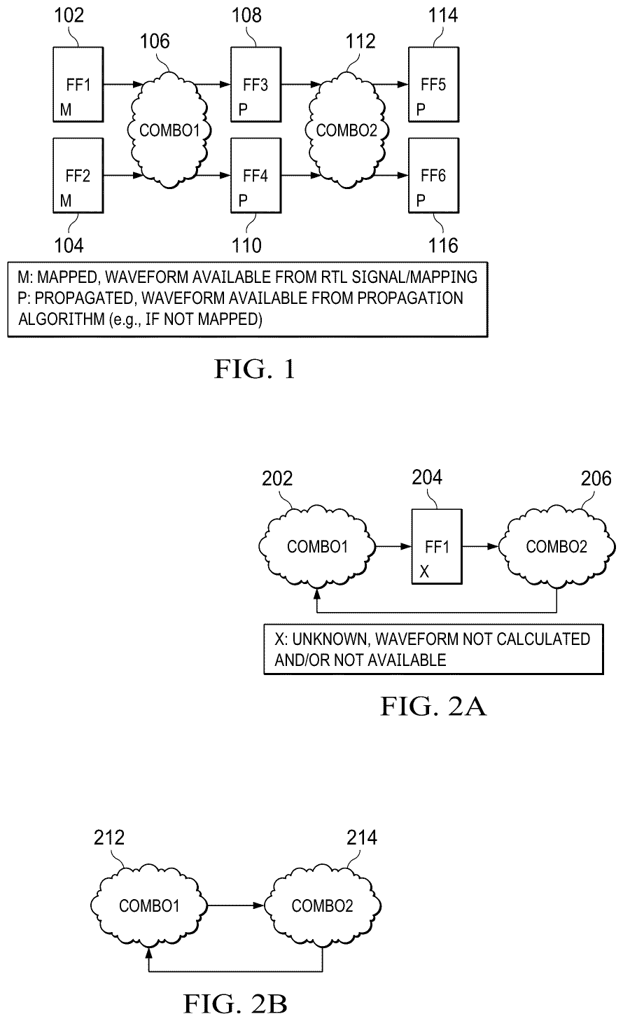

Waveforms of unmapped pins of sequential elements can sometimes be calculated, such as if the preceding sequential and/or combinational logic (e.g., in the fan-in) is all evaluated, then the unmapped pins of the sequential elements can be evaluated by waveform propagation, and waveform propagation of the fanout cone can also continue. A two-stage pipelined adder is one simple example of this. If the input pins of the adder are known, the propagation engine can calculate the waveforms on pins of internal and output flip-flops as shown in FIG. 1.

More specifically, FIG. 1 shows the two-stage pipelined adder in which a first flip-flop FF1 102 and a second flip-flop FF2 104 have input pins that are mapped (e.g., as indicated by ‘M’). The two-stage pipelined adder includes first combinational logic Combo1 106, a third flip-flop FF3 108, a fourth flip-flop FF4 110, second combinational logic Combo2 112, a fifth flip-flop FF5 114, and a sixth flip-flop FF6 116. The first combinational logic Combo1 106 has respective input pins electrically connected to the output pins of the first flip-flop FF1 102 and second flip-flop FF2 104. The third flip-flop FF3 108 and fourth flip-flop FF4 110 have respective input pins electrically connected to respective output pins of the first combinational logic Combo1 106. The second combinational logic Combo2 112 has respective input pins electrically connected to the output pins of the third flip-flop FF3 108 and fourth flip-flop FF4 110. The fifth flip-flop FF5 114 and sixth flip-flop FF6 116 have respective input pins electrically connected to respective output pins of the second combinational logic Combo2 112. Since the input pins of the first flip-flop FF1 102 and second flip-flop FF2 104 are mapped, and the waveforms of the corresponding signals are known, unmapped pins of subsequent elements, like the first combinational logic Combo1 106, second combinational logic Combo2 112, and the third through sixth flip-flops FF3-FF6 108, 110, 114, 116, can be evaluated by waveform propagation, and waveform propagation of the fanout cone can continue.

Unmapped pins of sequential elements can sometimes not be evaluated by waveform propagation, such as if a feedback loop occurs around the unmapped sequential element. FIG. 2A shows a simple example of a feedback loop around an unmapped sequential element (e.g., a sequential element having no mapped pins). The feedback loop includes first combinational logic Combo1 202, a first flip-flop FF1 204, and second combinational logic Combo2 206. An output pin of the first combinational logic Combo1 202 is electrically connected to an input pin of the first flip-flop FF1 204, and an output pin of the first flip-flop FF1 204 is electrically connected to an input pin of the second combinational logic Combo2 206. An output pin of the second combinational logic Combo2 206 is electrically connected to an input pin of the first combinational logic Combo1 202. Neither the input pin nor the output pin of the first flip-flop FF1 204 is mapped (e.g., as shown by the ‘X’). In such a situation, since a state of the feedback loop is not known, the state of the feedback loop may be non-deterministic and may, for example, oscillate between states in an unknown manner. A waveform on the input or output pin of the first flip-flop FF1 204 may not be calculated by waveform propagation and/or may not be available.

Additionally, FIG. 2B shows a simple example of a feedback loop that may not be evaluated using waveform propagation. The feedback loop includes first combinational logic Combo1 212 and second combinational logic Combo2 214. No sequential element is in the feedback loop. An output pin of the first combinational logic Combo1 212 is electrically connected to an input pin of the second combinational logic Combo2 214, and an output pin of the second combinational logic Combo2 214 is electrically connected to an input pin of the first combinational logic Combo1 212. If any of the first combinational logic Combo1 212 or second combinational logic Combo2 214 includes a state machine, a starting state of the respective combinational logic would be unknown, and hence, the operation of the feedback loop would not be known.

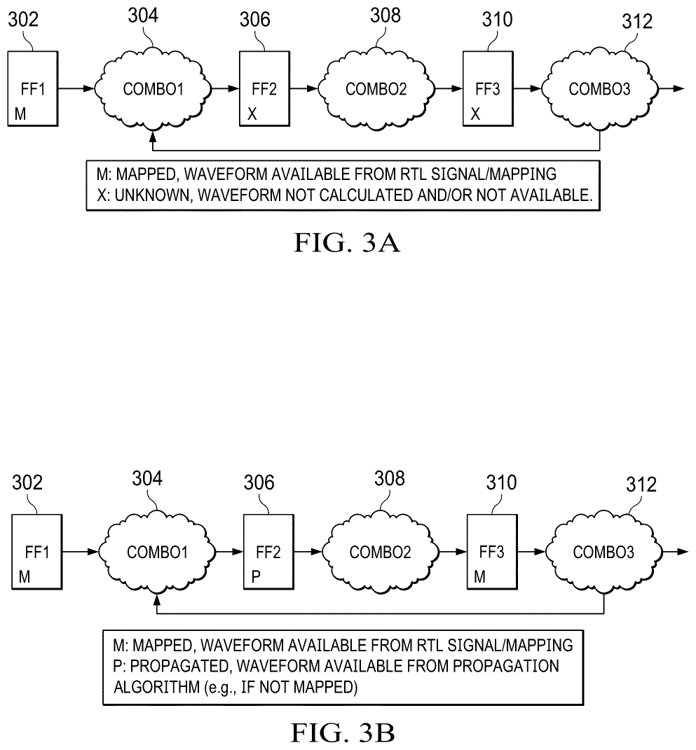

FIG. 3A shows a more complex example of a feedback loop around an unmapped sequential element. Two sequential elements are in the feedback loop, with each sequential element each having input and output pins that are unmapped in FIG. 3A. An output pin of a first flip-flop FF1 302 is electrically connected to an input pin of first combinational logic Combo1 304, which also has an input pin of the feedback loop. The input pin of the first flip-flop FF1 302 is mapped (e.g., as indicated by ‘M’). An output pin of the first combinational logic Combo1 304 is electrically connected to an input pin of a second flip-flop FF2 306, and an output pin of the second flip-flop FF2 306 is electrically connected to an input pin of the second combinational logic Combo2 308. An output pin of the second combinational logic Combo2 308 is electrically connected to an input pin of a third flip-flop FF3 310, and an output pin of the third flip-flop FF3 310 is electrically connected to an input pin of third combinational logic Combo3 312. An output pin of the third combinational logic Combo3 312 is electrically connected to an input pin of the first combinational logic Combo1 304 as feedback. The input pins and output pins of the second flip-flop FF2 306 and the third flip-flop FF3 310 are not mapped (e.g., as shown by ‘X’). With both the second flip-flop FF2 306 and the third flip-flop FF3 310 not being mapped, a state of the feedback loop is not known, and the state of the feedback loop may be non-deterministic and may, for example, oscillate between states in an unknown manner.

FIG. 3B shows another complex example of a feedback loop. The feedback loop of FIG. 3B is the same as the feedback loop of FIG. 3A, except the third flip-flop FF3 310 in the feedback loop has an input pin that is mapped (e.g., as shown by ‘M’). With the third flip-flop FF3 310 mapped, the loop is considered broken, and the loop may be evaluated by waveform propagation since the state of the first combinational logic Combo1 304, second combinational logic Combo2 308, third combinational logic Combo3 312, and the second flip-flop FF2 306 may be determined based on the mapping of the third flip-flop FF3 310. Similarly, the loop may be considered broken when the second flip-flop FF2 306 is mapped and the third flip-flop FF3 310 is unmapped.

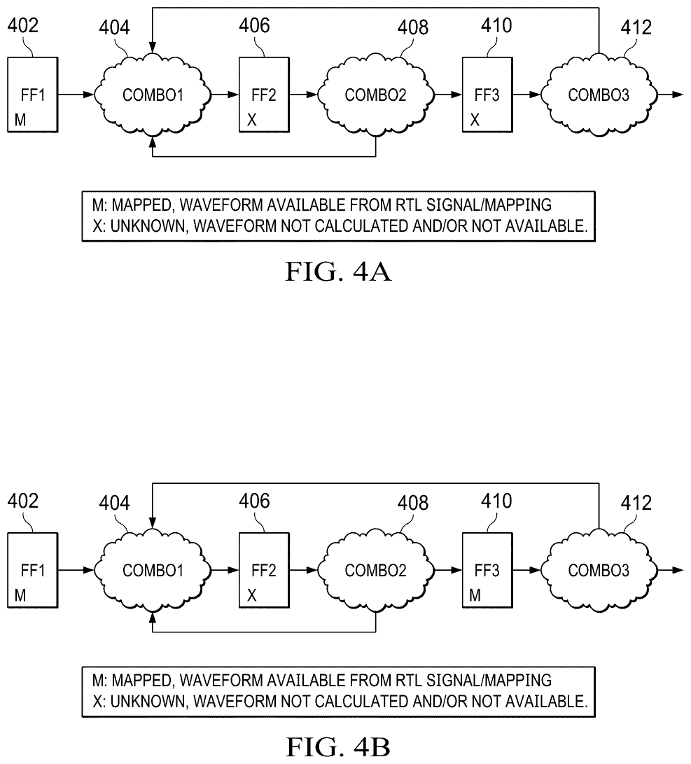

FIG. 4A shows another example of a feedback loop. FIG. 4A shows an inner loop and an outer loop. The inner loop includes first combinational logic Combo1 404, a second flip-flop FF2 406, and second combinational logic Combo2 408. The outer loop includes the first combinational logic Combo1 404, the second flip-flop FF2 406, the second combinational logic Combo2 408, a third flip-flop FF3 410, and third combinational logic Combo3 412. An output pin of a first flip-flop FF1 402 is electrically connected to an input pin of the first combinational logic Combo1 404, which also includes respective input pins of the feedback loops. The input pin of the first flip-flop FF1 402 is mapped (e.g., as indicated by ‘M’). An output pin of the first combinational logic Combo1 404 is electrically connected to an input pin of the second flip-flop FF2 406, and an output pin of the second flip-flop FF2 406 is electrically connected to an input pin of the second combinational logic Combo2 408. An output pin of the second combinational logic Combo2 408 is electrically connected to an input pin of a third flip-flop FF3 410, and an output pin of the third flip-flop FF3 410 is electrically connected to an input pin of the third combinational logic Combo3 412. Another output pin of the second combinational logic Combo2 408 is electrically connected to another input pin of the first combinational logic Combo1 404. An output pin of the third combinational logic Combo3 412 is electrically connected to another input pin of the first combinational logic Combo1 404. The input pins and output pins of the second flip-flop FF2 406 and the third flip-flop FF3 410 are not mapped (e.g., as shown by ‘X’). Under such circumstances, neither the inner loop nor the outer loop can be evaluated by waveform propagation.

FIG. 4B shows another complex example of a feedback loop. The feedback loop of FIG. 4B is the same as the feedback loop of FIG. 4A, except the input pin of the third flip-flop FF3 410 in the outer loop is mapped (e.g., as shown by ‘M’). With the third flip-flop FF3 410 mapped, the outer loop is considered broken, and some components of the outer loop may be evaluated by waveform propagation. However, the inner loop remains unbroken and cannot be evaluated by waveform propagation. If the second flip-flop FF2 406 was mapped, the inner and outer loops would be broken, and the inner and outer loops may be evaluated by waveform propagation.

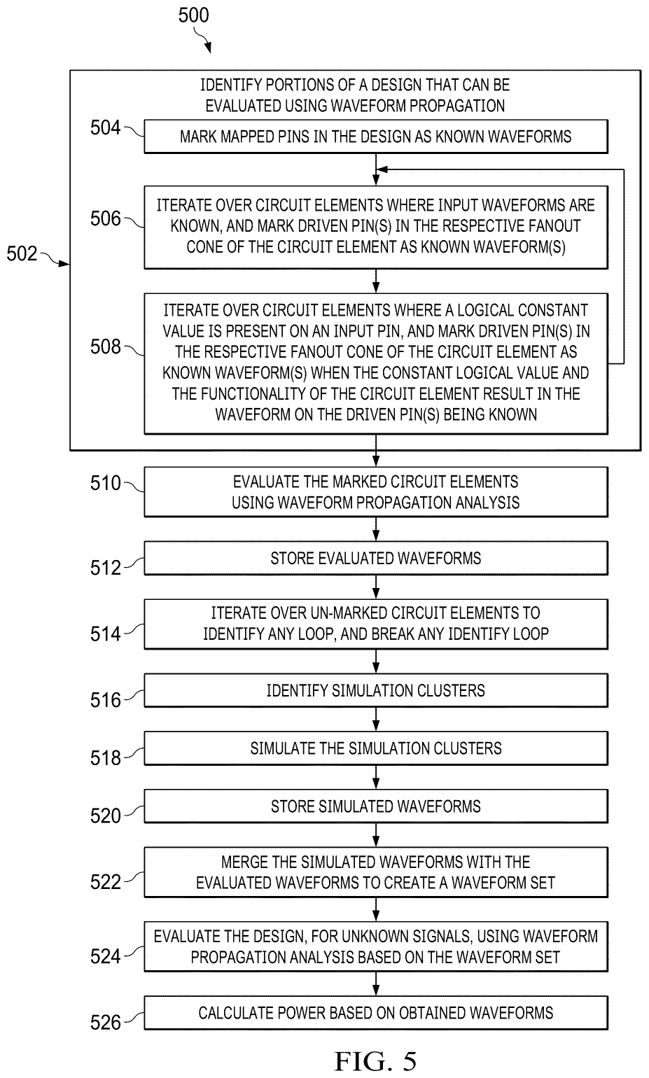

FIG. 5 is a flow chart of a method 500 of a hybrid waveform propagation and simulation approach according to some examples. Generally, the method 500 uses a hybrid approach of waveform evaluation where possible and simulation to solve, e.g., the sequential and combinational loop issues.

At block 502, portions of a design that can be evaluated using waveform propagation are identified. These portions may be any circuit element (e.g., sequential and/or combinational logic) in the design. Generally, any circuit element that has sufficiently known input waveforms and a known functionality may be deterministic and capable of being evaluated using waveform propagation. In some instances, all input waveforms to a circuit element (with a known functionality) may be known (e.g., by mapping and/or are capable of being calculated by waveform propagation), which permits the circuit element to be evaluated using waveform propagation. In some instances, not all input waveforms to a circuit element (with a known functionality) may be known, but with what is known and based on the known functionality, the circuit element may be evaluated using waveform propagation. Portions of a design (e.g., circuit elements) may be evaluated using waveform propagation more efficiently than a simulation approach. The portions may be identified by marking pins of the respective portions in the design, which may be by writing an attribute of the respective portions in the design (e.g., in the gate-level netlist).

To identify these portions at block 502, mapped pins of circuit elements in the design are marked as known waveforms at block 504. The RTL waveform is known on these pins, which may be input pins or output pins of various circuit elements. At block 506, circuit elements where the input waveforms are known are iterated over, and driven pin(s) in the respective fanout cone of the circuit element are marked as known waveforms. The driven pin(s) in the fanout cone may be electrically connected to an driven by an output pin of the circuit element, and hence, marking the driven pin(s) may include marking the output pin of the circuit element. If the function of a circuit element is known and, with the known input waveforms, is deterministic, the waveform at the output pin of the circuit element in which input waveforms are known may be calculated. For example, if a two-input AND gate has known waveforms on the two input pins, the output waveform on the output pin of the AND gate will be known as a logical AND of the known waveforms on the two input pins.

At block 508, circuit elements where a constant logical value is present on an input pin are iterated over, and driven pin(s) in the respective fanout cone of the circuit element are marked as known when the constant logical value and the functionality of the circuit element result in the waveform on the driven pin(s) being known. The driven pin(s) in the fanout cone may be electrically connected to an driven by an output pin of the circuit element, and hence, marking the driven pin(s) may include marking the output pin of the circuit element. The constant logical values may be tied to logical ‘0’ or ‘1’ in the design netlist, sometimes due to configuration fuses or other design reasons, which may not appear in a mapping file. Hence, the constant logical values may not be marked as known waveforms at block 504. Some circuit elements may have a known waveform on an output pin of the respective circuit element based on the presence of the constant logical value on an input pin. In some instances, the known waveform on the driven pin(s) may be a constant logical value or may be a known constant waveform input to the circuit element. The constant logical value may be propagated to the driven pin(s) for subsequent iterations of block 508. A waveform on an output pin of a circuit element may be marked as known, where the value for any stimulus time, the value of the waveform on the output pin of the circuit element is known from a mapped or calculated input waveform. If the algorithm is executed multiple times on several time slices or different tests, it is possible the constant waveform is present in some activity files and not present in some files, and the constant logical value may not be the same in all files.

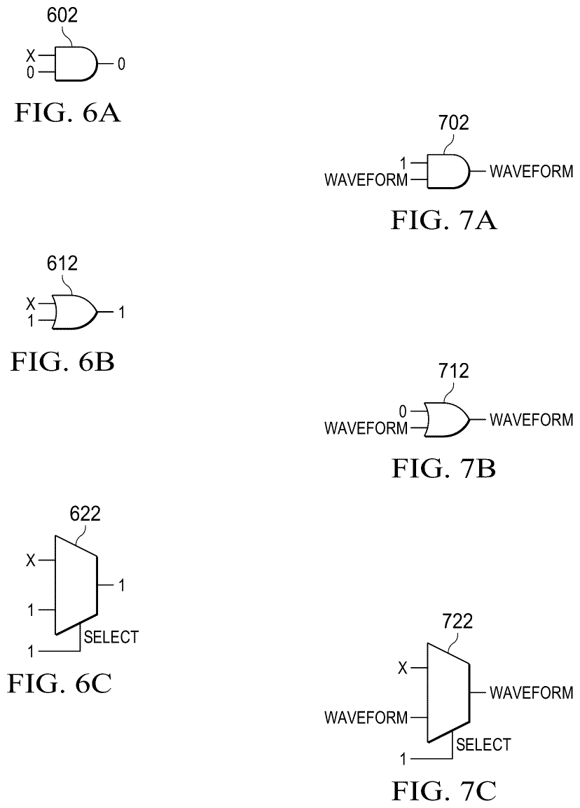

FIGS. 6A, 6B, and 6C illustrate example circuit elements where a constant logical value on an input pin of the respective circuit element results in a constant logical value on an output pin of the circuit element, such that the waveform on the output pin is known. In the examples of FIGS. 6A, 6B, and 6C, the waveform on the output pin may be known even though an input waveform is unknown. In FIG. 6A, an AND gate 602 may have an input signal that is a constant logical ‘0’, which causes the output waveform of the AND gate 602 to be a constant logical ‘0’ regardless of whether any other input waveform is known. In FIG. 6B, an OR gate 612 may have an input signal that is a constant logical ‘1’, which causes the output waveform of the OR gate 612 to be a constant logical ‘1’ regardless of whether any other input waveform is known. In FIG. 6C, a multiplexer (MUX) 622 has an input signal that is a constant logical ‘1’ and a select signal that is a constant logical value that selects the constant logical ‘1’. The output waveform of the MUX 622 will be a constant logical ‘1’ regardless of whether any other input waveform is known.

FIGS. 7A, 7B, and 7C illustrate example circuit elements where a constant logical value on an input pin of the respective circuit element results in a known constant waveform on an output pin of the circuit element, such that the waveform on the output pin is known. In FIG. 7A, an AND gate 702 may have a first input signal that is a constant logical ‘l’ and a second input signal that is a known waveform, which causes the output waveform on the output pin of the AND gate 702 to be the known constant waveform of the second input signal. In FIG. 7B, an OR gate 712 may have a first input signal that is a constant logical ‘0’ and a second input signal that is a known waveform, which causes the output waveform on the output pin of the OR gate 712 to be the known constant waveform of the second input signal. In FIG. 7C, a multiplexer (MUX) 722 has an input waveform that is known and a select waveform that is a constant logical value that selects the known input waveform. The output waveform on the output pin of the MUX 722 will be the known input waveform regardless of whether any other input waveform is known.

In some instances, a driven pin of a circuit element may not be marked as known when a constant logical value is present on an input pin and the functionality of the circuit element is known because the waveform on the driven pin may not be known. For example, assume that the respective waveforms input to the AND gate 702 and OR gate 712 in FIGS. 7A and 7B, respectively, are not known (instead of known as described above), then the waveforms on the output pins of the AND gate 702 and OR gate 712 would not be known.

Referring back to FIG. 5, blocks 506 and 508 may be repeated until the design has been iterated over such that each appropriate circuit element of the design is identified. Generally, the operation of blocks 506 and 508, and any iteration of those blocks, identifies pins in the design that may be known deterministically based off of the mapped pins and known functionality of circuit elements. This operation marks, e.g., from top-level input pins of the design as far in fanout cones to pins of circuit elements on which waveforms may be deterministically calculated. Circuit elements that can be calculated using waveform propagation are identified and marked.

At block 510, the marked circuit elements are evaluated using waveform propagation. An example algorithm for waveform propagation is described in U.S. Pat. No. 12,001,317, which is incorporated herein by reference in its entirety. At block 512, the evaluated waveforms are stored, such as in a waveform database. The stored waveforms, in some examples, include waveforms for pins that are inputs to un-marked circuit element(s) (e.g., a circuit element that has an input pin (a driven pin driven by another circuit element) that is not marked as a known waveform).

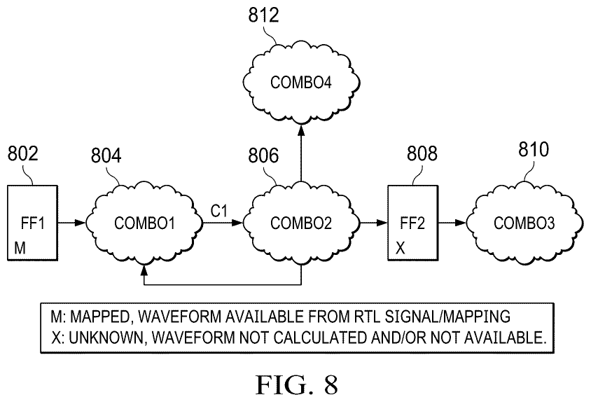

At block 514, un-marked circuit elements (e.g., circuit elements having respective output pins that are not marked as known) are iterated over to identity any loops in which any un-marked circuit element is present, and any loop that is identified is broken. Any loop may not include within the loop a pin with a known, mapped waveform. If any loop (e.g., combinational loop) is identified, one or more pins is identified to break the loop. A pin is marked so that the waveform on the pin may be saved during simulation, and the pin is marked as known in the netlist for later waveform propagation analysis. An example of this marking is shown in FIG. 8.

FIG. 8 shows a combinational loop including first combinational logic Combo1 804 and second combinational logic Combo2 806. An output pin of a first flip-flop FF1 802 is electrically connected to an input pin of the first combinational logic Combo1 804. An output pin of the first combinational logic Combo1 804 is electrically connected to an input pin of the second combinational logic Combo2 806, and a first output pin of the second combinational logic Combo2 806 is electrically connected to an input pin of the first combinational logic Combo1 804. A second output pin of the second combinational logic Combo2 806 is electrically connected to an input pin of a second flip-flop FF2 808. An output pin of the second flip-flop FF2 808 is electrically connected to an input pin of third combinational logic Combo3 810. Another output pin of the second combinational logic Combo2 806 is electrically connected to an input pin of fourth combinational logic Combo4 812.

To break the loop formed by the first combinational logic Combo1 804 and second combinational logic Combo2 806, a pin, such as pin C1, which is the node connecting the output pin of the first combinational logic Combo1 804 to the second combinational logic Combo2 806, is marked. The waveform on pin C1 from simulation is saved so that the waveform on pin C1 may be used in a waveform propagation analysis later.

Without marking such a pin, the loop may not be able to be evaluated by waveform propagation analysis since the starting states of any of the first combinational logic Combo1 804 or second combinational logic Combo2 806 is not known (like described above with respect to FIG. 2B), even when an input pin of the first flip-flop FF1 802 is mapped. However, with the pin C1 marked in this example, the waveform on the pin C1 may be obtained from simulation, which may be used subsequently in a waveform propagation analysis.

Referring back to FIG. 5, at block 516, simulation clusters are identified. To identify the simulation clusters, unmarked circuit elements (e.g., unmarked prior to breaking any loop) are iterated over. For each unmarked circuit element, any circuit element within the fanout cone of the unmarked circuit element and that is also not marked as evaluated may be added to a simulation cluster for that unmarked circuit element. In some instances, the simulation cluster may not include the full fanout cone of the unmarked circuit element because some circuit element within the fanout cone may be known due to marking within block 502 or because the behavior of an unmarked circuit element may not be needed to determine non-deterministic behavior. A simulation cluster may be a minimal, non-deterministic cluster of circuit elements. For example, referring to FIG. 8, the third combinational logic Combo3 810 and the fourth combinational logic Combo4 812 are not within the loop that includes the first combinational logic Combo1 804 and second combinational logic Combo2 806. Hence, a minimal, non-deterministic cluster may include the first combinational logic Combo1 804 and second combinational logic Combo2 806, while excluding the third combinational logic Combo3 810 and fourth combinational logic Combo4 812. Hence, a cluster, in some instances, may not include a deterministic circuit element outside of the loop. The iterations may identify N sets or clusters for simulation.

Simulation based algorithms may be more efficient when a certain size circuit is to be simulated. Depending on the number of cycles, number of clusters required, and the simulation compile or runtime, this cluster size can vary. As each simulation cluster may be independent, one or any number of the clusters can be grouped together and simulated as a single cluster group. Hence, in some examples, the simulation clusters may be grouped to form M cluster groups, where M is less than N.

At block 518, the simulation clusters are simulated, which may be by cluster groups. The simulation may be a time-based simulation. In some examples, sequential elements are initialized to zero, one, a random value, or a user-defined value. A corresponding reset signal may be used for a sequential element (e.g., a flip-flop) to choose between zero and one if the user does not specify the starting value. Simulation time is advanced to simulate each gate element in the simulation cluster and/or cluster group. The simulation of a simulation cluster or cluster group can be split into T number of time-based slices, and each slice may be run in parallel. The initial value indeterminism of a slice may occur at the start of the respective slice. However, the parallel benefits of this solution often outweigh the slight initial value concerns.

At block 520, simulated waveforms are stored. Waveforms for sequential elements and any combinational loop-break signals are saved from the simulation. Optionally, waveforms for any other simulated signals may be saved.

At block 522, simulated waveform data is merged into the evaluated waveform data set to create a waveform set. Merging this data may obtain waveforms for all pins of sequential elements, combinational break signals, or all gate-level pins or nodes in the design.

At block 524, the design is evaluated for unknown signals using waveform propagation analysis based on the waveform set. The unknown signals may be, for example, in a fanout of a non-deterministic cluster. For example, deterministic circuit elements in a fanout of a non-deterministic cluster may be excluded from simulation as described above. However, since such a circuit element has a non-deterministic cluster in a fan-in, and hence, may not have all input waveforms known at block 502, an output waveform of the circuit element may be unknown. Performing the evaluation using waveform propagation at block 524, which may be performed with waveforms of pins of non-deterministic clusters generated by the simulation of block 518, may permit the output waveforms of the circuit elements to be calculated. A propagation engine may be re-executed to calculate values for any unknown signals. This evaluation may be for clusters selected for the simulation engine where the waveforms were not saved.

At block 526, power is calculated using a gate-level power calculation algorithm based on obtained waveforms. Power may be calculated using various gate-level power calculation algorithms as activity is known for the gate-level pins or nodes.

The method 500 of FIG. 5 may be embodied as instructions stored on a non-transitory computer-readable medium, which instructions are executable by one or more processors of one or more computer systems. In some examples, the functionality of the method 500 may be distributed across a number of computer systems, e.g., interconnected via a network. For example, an evaluation engine for performing blocks 510, 524 may be distributed across a first one or more computer systems, and a simulation engine for performing block 518 may be distributed across a second one or more computer systems. A hybrid engine for performing blocks 502 (including blocks 504-508), 514, 516, 522 may executed on a third one or more computer systems. A power calculation engine for performing block 526 may be distributed across a fourth one or more computer systems. A database executing on a fifth one or more computer systems may store data at blocks 512, 520. The above-described engines and database may each be or include instructions on a non-transitory computer-readable medium (e.g., memory), which instructions are executable by one or more processors of the respective one or more computer systems to perform the above-described functionality. In some examples, the method 500 of FIG. 5 may be implemented on a single computer system. Any variation and permutation of the various engines and database operating on any number of computer systems, together or separately, may be implemented in other examples. An example computer system is described below.

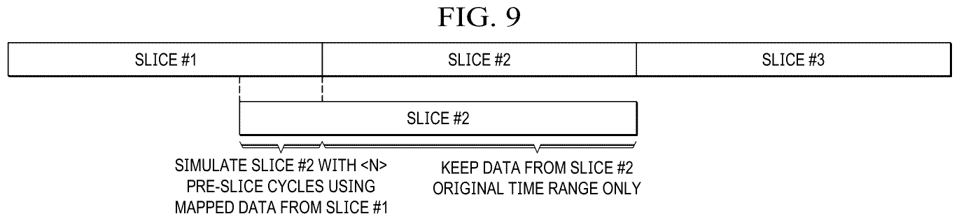

FIG. 9 illustrates aspects of simulation according to some examples. For a simulation, a time slice may be overlapped with another time slice to minimize initial state error that can occur. FIG. 9 illustrates three sequential time slices Slice #1, Slice #2, Slice #3. The initial state of flip-flops at the start of a given slice are either 0, 1, user-defined, or set by the set/reset state of the data output (Q) or inverse data output (QN) pins. The state of the flip-flop has some probability of error when the initial state is set. As the circuit is simulated and the logic values evaluated, with each known or mapped flip-flop forced to the correct value, the state of the unknown and unmapped flip-flops trends to the correct value. There may be no guarantee that the state is correct; however, it is more likely that the state is correct as time progresses. For this reason, a time slice can be overlapped with a preceding time slice by n number of cycles, such as by 100, 1000, or a user-specified number of cycles. As an example, in FIG. 9, the second slice Slice #2 is extended <n> number of pre-slice cycles to overlap with the preceding first slice Slice #1. The extension adds and prepends the <n> number of pre-slice cycles at the beginning of the slice. The overlap is used to simulate the circuit with known mapped values to increase chance that the unknown/unmapped sequential cells will be in the correct state at the start of the calculated time slice.

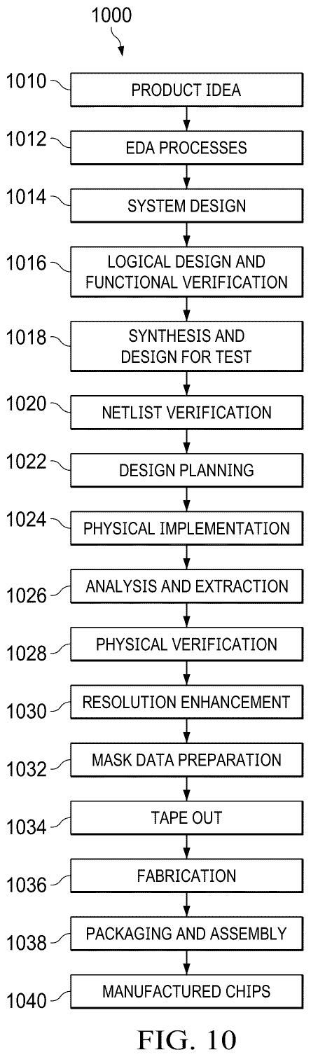

FIG. 10 illustrates an example set of processes 1000 used during the design, verification, and fabrication of an article of manufacture such as an integrated circuit to transform and verify design data and instructions that represent the integrated circuit. Each of these processes can be structured and enabled as multiple modules or operations. The term ‘EDA’ signifies the term ‘Electronic Design Automation.’ These processes start with the creation of a product idea 1010 with information supplied by a designer, information which is transformed to create an article of manufacture that uses a set of EDA processes 1012. When the design is finalized, the design is taped-out 1034, which is when artwork (e.g., geometric patterns) for the integrated circuit is sent to a fabrication facility to manufacture the mask set, which is then used to manufacture the integrated circuit. After tape-out, a semiconductor die is fabricated 1036 and packaging and assembly processes 1038 are performed to produce the finished integrated circuit 1040.

Specifications for a circuit or electronic structure may range from low-level transistor material layouts to high-level description languages. A high-level of representation may be used to design circuits and systems, using a hardware description language (HDL) such as VHDL, Verilog, System Verilog, SystemC, MyHDL or Open Vera. The HDL description can be transformed to a logic-level register transfer level (RTL) description, a gate-level description, a layout-level description, or a mask-level description. Each lower representation level that is a more detailed description adds more useful detail into the design description, for example, more details for the modules that include the description. The lower levels of representation that are more detailed descriptions can be generated by a computer, derived from a design library, or created by another design automation process. An example of a specification language at a lower level of representation language for specifying more detailed descriptions is SPICE, which is used for detailed descriptions of circuits with many analog components. Descriptions at each level of representation are enabled for use by the corresponding systems of that layer (e.g., a formal verification system). A design process may use a sequence depicted in FIG. 10. The processes described by be enabled by EDA products (or EDA systems).

During system design 1014, functionality of an integrated circuit to be manufactured is specified. The design may be optimized for desired characteristics such as power consumption, performance, area (physical and/or lines of code), and reduction of costs, etc. Partitioning of the design into different types of modules or components can occur at this stage.

During logic design and functional verification 1016, modules or components in the circuit are specified in one or more description languages and the specification is checked for functional accuracy. For example, the components of the circuit may be verified to generate outputs that match the requirements of the specification of the circuit or system being designed. The method 500 of FIG. 5 may be implemented during logic design and functional verification 1016. Functional verification may use simulators and other programs such as testbench generators, static HDL checkers, and formal verifiers. In some embodiments, special systems of components referred to as ‘emulators’ or ‘prototyping systems’ are used to speed up the functional verification.

During synthesis and design for test 1018, HDL code is transformed to a netlist. In some embodiments, a netlist may be a graph structure where edges of the graph structure represent components of a circuit and where the nodes of the graph structure represent how the components are interconnected. Both the HDL code and the netlist are hierarchical articles of manufacture that can be used by an EDA product to verify that the integrated circuit, when manufactured, performs according to the specified design. The netlist can be optimized for a target semiconductor manufacturing technology. Additionally, the finished integrated circuit may be tested to verify that the integrated circuit satisfies the requirements of the specification.

During netlist verification 1020, the netlist is checked for compliance with timing constraints and for correspondence with the HDL code. During design planning 1022, an overall floor plan for the integrated circuit is constructed and analyzed for timing and top-level routing.

During layout or physical implementation 1024, physical placement (positioning of circuit components such as transistors or capacitors) and routing (connection of the circuit components by multiple conductors) occurs, and the selection of cells from a library to enable specific logic functions can be performed. As used herein, the term ‘cell’ may specify a set of transistors, other components, and interconnections that provides a Boolean logic function (e.g., AND, OR, NOT, XOR) or a storage function (such as a flip-flop or latch). As used herein, a circuit ‘block’ may refer to two or more cells. Both a cell and a circuit block can be referred to as a module or component and are enabled as both physical structures and in simulations. Parameters are specified for selected cells (based on ‘standard cells’) such as size and made accessible in a database for use by EDA products.

During analysis and extraction 1026, the circuit function is verified at the layout level, which permits refinement of the layout design. During physical verification 1028, the layout design is checked to ensure that manufacturing constraints are correct, such as DRC constraints, electrical constraints, lithographic constraints, and that circuitry function matches the HDL design specification. During resolution enhancement 1030, the geometry of the layout is transformed to improve how the circuit design is manufactured.

During tape-out, data is created to be used (after lithographic enhancements are applied if appropriate) for production of lithography masks. During mask data preparation 1032, the ‘tape-out’ data is used to produce lithography masks that are used to produce finished integrated circuits.

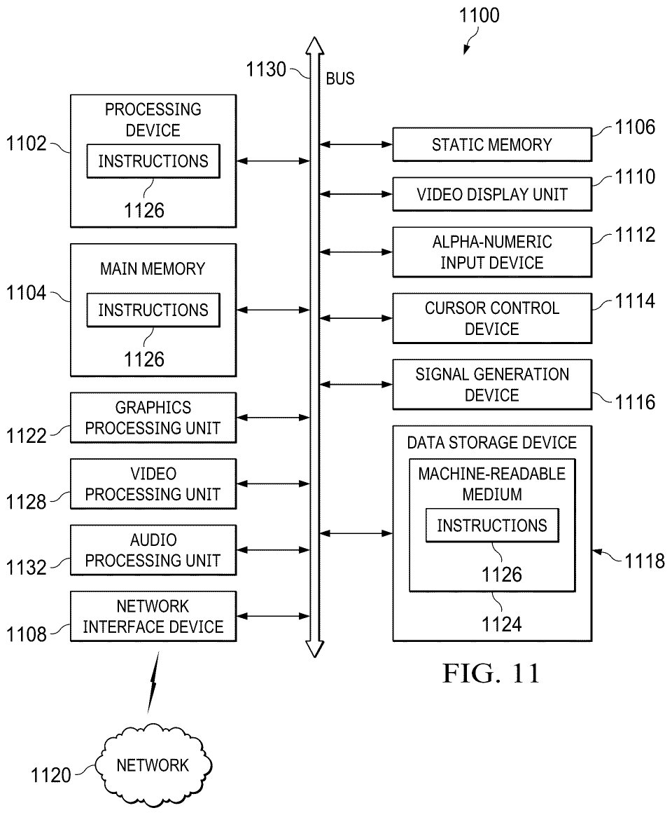

A storage subsystem of a computer system (such as computer system 1100 of FIG. 11) may be used to store the programs and data structures that are used by some or all of the EDA products described herein, and products used for development of cells for the library and for physical and logical design that use the library.

An example is a method. One or more first portions of a design that are capable of being evaluated using waveform propagation are identified using one or more processors. The identified one or more first portions of the design are evaluated using waveform propagation. One or more second portions of the design that are not capable of being evaluated using waveform propagation are identified. Operation of the one or more second portions of the design is simulated. A waveform obtained by simulating operation of the one or more second portions is merged with waveforms evaluated using waveform propagation to obtain a waveform set. The design is evaluated for unknown signals based on the waveform set. Power consumption of the design is calculated based on evaluating the design.

Another example is a method. Respective pins of circuit elements of a design that are capable of being evaluated using waveform propagation are marked using one or more processors. The marked pins are evaluated using waveform propagation. Evaluating the marked pins includes determining waveforms on respective ones of at least some of the marked pins. Loops in the design are broken. Breaking the loops includes marking, for each loop of the loops, a loop pin in the respective loop to store a waveform on the loop pin during simulation. Clusters of circuit elements of the design that are not capable of being evaluated using waveform propagation are identified. The clusters include the broken loops. Operation of the clusters is simulated. The simulating uses corresponding waveforms determined by the evaluation of the marked pins as input signals to the clusters. The simulating includes storing waveforms of the marked loop pins determined in the simulation.

A further example is a non-transitory computer-readable storage medium that includes stored instructions. The instructions, which when executed by one or more processors, cause the one or more processors to: mark respective pins of circuit elements of a design that are capable of being evaluated using waveform propagation and identify clusters of circuit elements of the design that are not capable of being evaluated using waveform propagation. Marking respective pins of circuit elements of the design that are capable of being evaluated using waveform propagation includes marking the respective pins as known waveforms. For a respective circuit element: where a pin of the respective circuit element that is mapped to a waveform, the pin is marked as a known waveform; where the respective circuit element has all input pins marked as known waveforms, an output pin of the respective circuit element is marked as a known waveform; and where a constant logical value is on an input pin of the respective circuit element and the constant logical value on the input pin and functionality of the respective circuit element result in a waveform on an output pin of the respective circuit element being known, the output pin of the respective circuit element is marked as a known waveform.

IG. 11 illustrates an example machine of a computer system 1100 within which a set of instructions, for causing the machine to perform any one or more of the methodologies discussed herein, may be executed. In alternative implementations, the machine may be connected (e.g., networked) to other machines in a LAN, an intranet, an extranet, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 1100 includes a processing device 1102, a main memory 1104 (e.g., read-only memory (ROM), flash memory, dynamic random access memory (DRAM) such as synchronous DRAM (SDRAM), a static memory 1106 (e.g., flash memory, static random access memory (SRAM), etc.), and a data storage device 1118, which communicate with each other via a bus 1130.

Processing device 1102 represents one or more processors such as a microprocessor, a central processing unit, or the like. More particularly, the processing device may be complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 1102 may also be one or more special-purpose processing devices such as an application specific integrated circuit (ASIC), a field programmable gate array (FPGA), a digital signal processor (DSP), network processor, or the like. The processing device 1102 may be configured to execute instructions 1126 for performing the operations and steps described herein.

The computer system 1100 may further include a network interface device 1108 to communicate over the network 1120. The computer system 1100 also may include a video display unit 1110 (e.g., a liquid crystal display (LCD) or a cathode ray tube (CRT)), an alphanumeric input device 1112 (e.g., a keyboard), a cursor control device 1114 (e.g., a mouse), a signal generation device 1116 (e.g., a speaker), graphics processing unit 1122, video processing unit 1128, and audio processing unit 1132.

The data storage device 1118 may include a machine-readable storage medium 1124 (also known as a non-transitory computer-readable storage medium) on which is stored one or more sets of instructions 1126 or software embodying any one or more of the methodologies or functions described herein. The instructions 1126 may also reside, completely or at least partially, within the main memory 1104 and/or within the processing device 1102 during execution thereof by the computer system 1100, the main memory 1104 and the processing device 1102 also constituting machine-readable storage media.

In some implementations, the instructions 1126 include instructions to implement functionality corresponding to the present disclosure. While the machine-readable storage medium 1124 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine and the processing device 1102 to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm may be a sequence of operations leading to a desired result. The operations are those requiring physical manipulations of physical quantities. Such quantities may take the form of electrical or magnetic signals capable of being stored, combined, compared, and otherwise manipulated. Such signals may be referred to as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the present disclosure, it is appreciated that throughout the description, certain terms refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may include a computer selectively activated or reconfigured by a computer program stored in the computer. Such a computer program may be stored in a non-transitory computer-readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various other systems may be used with programs in accordance with the teachings herein, or it may prove convenient to construct a more specialized apparatus to perform the method. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable storage medium having stored thereon instructions, which may be used to program a computer system (or other electronic devices) to perform a process according to the present disclosure. A machine-readable storage medium includes any mechanism for storing information in a form readable by a machine (e.g., a computer). For example, a machine-readable (e.g., a computer-readable) storage medium includes a machine-readable (e.g., a computer-readable) storage medium such as a read only memory (ROM), random access memory (RAM), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. Where the disclosure refers to some elements in the singular tense, more than one element can be depicted in the figures and like elements are labeled with like numerals. The disclosure and drawings are, accordingly, to be regarded in an illustrative sense rather than a restrictive sense.

What is claimed is:

1. A method comprising:
identifying, using one or more processors, one or more first portions of a design that are capable of being evaluated using waveform propagation;
evaluating the identified one or more first portions of the design using waveform propagation;
identifying one or more second portions of the design that are not capable of being evaluated using waveform propagation;
simulating operation of the one or more second portions of the design;
merging a waveform obtained by simulating operation of the one or more second portions with waveforms evaluated using waveform propagation to obtain a waveform set;
evaluating the design for unknown signals based on the waveform set; and
calculating power consumption of the design based on evaluating the design.

2. The method of claim 1, wherein identifying the one or more first portions of the design comprises marking mapped pins of circuit elements of the design.

3. The method of claim 2, wherein the circuit elements include sequential elements.

4. The method of claim 1, wherein identifying the one or more first portions of the design comprises marking an output pin of a circuit element that has known input waveforms on respective input pins of the circuit element.

5. The method of claim 1, wherein identifying the one or more first portions of the design comprises marking an output pin of a circuit element of the design that has a constant logical value.

6. The method of claim 1, wherein identifying the one or more first portions of the design comprises marking an output pin of a circuit element of the design that has a known constant waveform.

7. The method of claim 1, wherein identifying the one or more second portions of the design comprises breaking a loop, breaking the loop comprising marking a signal in the loop for saving during simulation.

8. The method of claim 1, wherein each second portion of the one or more second portions of the design is a minimal, non-deterministic cluster of circuit elements.

9. The method of claim 1, wherein simulating operation of the one or more second portions of the design includes:
forming time slices for simulation; and
extending a time slice of the time slices to overlap a preceding time slice.

10. A method comprising:
marking, using one or more processors, respective pins of circuit elements of a design that are capable of being evaluated using waveform propagation;
evaluating the marked pins using waveform propagation, evaluating the marked pins including determining waveforms on respective ones of at least some of the marked pins;
breaking loops in the design comprising marking, for each loop of the loops, a loop pin in the respective loop to store a waveform on the loop pin during simulation;
identifying clusters of circuit elements of the design that are not capable of being evaluated using waveform propagation, wherein the clusters include the broken loops; and
simulating operation of the clusters, the simulating using corresponding waveforms determined by the evaluation of the marked pins as input signals to the clusters, the simulating comprising storing waveforms of the marked loop pins determined in the simulation.

11. The method of claim 10, further comprising
merging, in a waveform set, at least some of the waveforms of the marked loop pins determined in the simulation with waveforms evaluated using the waveform propagation;
evaluating the design for unknown signals based on the waveform set; and
calculating power consumption of the design based on evaluating the design.

12. The method of claim 10, wherein marking the respective pins of circuit elements of the design that are capable of being evaluated using waveform propagation includes:
marking, as respective known waveforms, pins of circuit elements of the design that are mapped to a respective waveform;
marking, as respective known waveforms, output pins of circuit elements of the design that have all respective input pins marked as known waveforms; and
marking, as respective known waveforms, output pins of circuit elements of the design where, for a respective circuit element, a respective constant logical value on an input pin of the respective circuit element and functionality of the circuit element result in a waveform on the output pin of the respective circuit element being known.

13. The method of claim 10, wherein each cluster of the clusters is a minimal, non-deterministic group of circuit elements.

14. The method of claim 10, wherein simulating operation of the clusters includes, for a cluster of the clusters:
forming time slices for simulation; and
extending a time slice of the time slices to overlap a preceding time slice.

15. A non-transitory computer-readable storage medium comprising stored instructions, which when executed by one or more processors, cause the one or more processors to:
mark respective pins of circuit elements of a design that are capable of being evaluated using waveform propagation comprising marking the respective pins as known waveforms, wherein, for a respective circuit element:
where a pin of the respective circuit element that is mapped to a waveform, the pin is marked as a known waveform;
where the respective circuit element has all input pins marked as known waveforms, an output pin of the respective circuit element is marked as a known waveform; and
where a constant logical value is on an input pin of the respective circuit element and the constant logical value on the input pin and functionality of the respective circuit element result in a waveform on an output pin of the respective circuit element being known, the output pin of the respective circuit element is marked as a known waveform; and
identify clusters of circuit elements of the design that are not capable of being evaluated using waveform propagation.

16. The non-transitory computer-readable storage medium of claim 15, wherein each cluster of the clusters is a minimal, non-deterministic cluster of circuit elements.

17. The non-transitory computer-readable storage medium of claim 15, wherein the instructions, which when executed by the one or more processors, cause the one or more processors to: break a loop in the design comprising marking a loop pin in the respective loop to store a waveform on the loop pin during simulation.

18. The non-transitory computer-readable storage medium of claim 15, wherein each cluster of the clusters includes a loop.

19. The non-transitory computer-readable storage medium of claim 18, wherein for each cluster of the clusters, the respective loop does not include within the loop a pin with a known, mapped waveform.

20. The non-transitory computer-readable storage medium of claim 18, wherein each cluster of the clusters does not include a deterministic circuit element outside of the loop.
